(19) United States
(12) Patent Application Publication
(10) Pub. No.: US 2026/0296234 A1
(43) Pub. Date: Oct. 1, 2026

(54) POWER INTEGRATION CIRCUIT WITH MOTOR DRIVE AND BATTERY CHARGING AND DISCHARGING FUNCTION

(71) Applicant: DELTA ELECTRONICS, INC., Taoyuan City (TW)

(72) Inventors: Chih-Chia LIAO, Taoyuan City (TW); Cheng-Chung LI, Taoyuan City (TW); Wen-Chieh TSAI, Taoyuan City (TW); Hsieh-Hsiung CHENG, Taoyuan City (TW)

(21) Appl. No.: 19/683,552

(22) Filed: May 20, 2026

Related U.S. Application Data
(63) Continuation of application No. 17/981,605, filed on Nov. 7, 2022, now Pat. No. 12,662,007.
(60) Provisional application No. 63/276,866, filed on Nov. 8, 2021.

(30) Foreign Application Priority Data
Sep. 21, 2022 (TW) 111135642

(51) Int. Cl. B60L 53/22; B60L 53/10; H02P 27/06

(52) U.S. Cl. CPC B60L 53/22; B60L 53/11; H02P 27/06; B60L 2210/12

(57) ABSTRACT

A power integration circuit includes an inverter and a charger. The inverter includes first, second, and third bridge arms configured to be coupled to first, second, and third inductors of a motor, respectively. Each bridge arm includes an upper switch and a lower switch. The charger is configured without a front-end DC conversion path and shares at least one bridge arm of the inverter and at least one inductor of the motor. In one configuration, a switch of the charger is configured to be coupled between a DC power apparatus and any one of the inductors. In another configuration, switches of the charger are configured to be coupled between the DC power apparatus and two of the inductors. The charger operates in a boost mode to charge a battery and in a buck mode to discharge the battery.

### CROSS-REFERENCE TO RELATED APPLICATIONS

This application is a continuation of U.S. patent application Ser. No. 17/981,605, filed on Nov. 7, 2022, which claims the benefit of U.S. Provisional Patent Application No. 63/276,866, filed on Nov. 8, 2021, and claims priority to Taiwan Patent Application No. 111135642, filed on Sep. 21, 2022. The entire disclosures of the above applications are incorporated herein by reference for all purposes.

### BACKGROUND

### Technical Field

The present disclosure relates to a power integration system, and more particularly to a power integration system with motor drive and battery charging and discharging function.

### Description of Related Art

The statements in this section merely provide background information related to the present disclosure and do not necessarily constitute prior art.

The current light electric vehicle system includes a motor driver and a charger, wherein the charger is divided into the on-board charger and the off-board charger. Since the chargers have different battery specifications, various manufacturers will introduce dedicated off-board chargers for users to use, and the disadvantage is that the chargers are not compatible with different vehicles, which makes it inconvenient to carry.

### SUMMARY

The disclosure provides a power integration circuit which includes an inverter and a charger. The inverter includes a first bridge arm, a second bridge arm, and a third bridge arm. Each of the first bridge arm, the second bridge arm, and the third bridge arm includes an upper switch and a lower switch. The first bridge arm is configured to be coupled to a first inductor of a motor, the second bridge arm is configured to be coupled to a second inductor of the motor, and the third bridge arm is configured to be coupled to a third inductor of the motor. The charger is configured without a front-end DC conversion path and is configured to share at least one bridge arm of the inverter and at least one inductor of the motor.

In some embodiments, the charger includes a switch configured to be coupled between a DC power apparatus and any one of the first inductor, the second inductor, and the third inductor. When the switch is coupled between the DC power apparatus and the first inductor, the charger is configured to charge a battery through the second bridge arm and the third bridge arm, or through one of the second bridge arm and the third bridge arm. The charger is configured to operate in a boost mode to charge the battery and to operate in a buck mode to discharge the battery to a power-receiving apparatus.

In some embodiments, the charger includes a first switch and a second switch. The first switch is configured to be coupled between the DC power apparatus and the first inductor, and the second switch is configured to be coupled between the DC power apparatus and the second inductor. By turning on or turning off the first switch and the second switch, DC power provided by the DC power apparatus is supplied to the power integration circuit through the first inductor and the second inductor, and power is outputted through the third inductor. The charger is configured to operate in the boost mode to charge the battery and to operate in the buck mode to discharge the battery to the power-receiving apparatus.

In some embodiments, the inverter is configured to receive power from the battery to drive the motor in a motor driving operation different from charging of the battery and discharging of the battery to the power-receiving apparatus.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The present disclosure can be more fully understood by reading the following detailed description of the embodiment, with reference made to the accompanying drawing as follows:

FIG. 1 is a block diagram of the power integration system with motor drive and battery charging and discharging function used with the DC power apparatus according to the present disclosure.

FIG. 2A is a block circuit diagram of a first embodiment of a charger of a power integration circuit without a front-end DC conversion path according to the present disclosure.

FIG. 2B is a block circuit diagram of a second embodiment of the charger of the power integration circuit without the front-end DC conversion path according to the present disclosure.

FIG. 3A is a block circuit diagram of a third embodiment of the charger of the power integration circuit without the front-end DC conversion path according to the present disclosure.

FIG. 3B is a block circuit diagram of a fourth embodiment of the charger of the power integration circuit without the front-end DC conversion path according to the present disclosure.

FIG. 4A is a block circuit diagram of a fifth embodiment of the charger of the power integration circuit without the front-end DC conversion path according to the present disclosure.

FIG. 4B is a block circuit diagram of FIG. 4A according to a first embodiment of the present disclosure.

FIG. 4C is a block circuit diagram of FIG. 4A according to a second embodiment of the present disclosure.

FIG. 5 is a block circuit diagram of a first embodiment of the charger of the power integration circuit with the front-end DC conversion path according to the present disclosure.

FIG. 6 is a block circuit diagram of a second embodiment of the charger of the power integration circuit with the front-end DC conversion path according to the present disclosure.

FIG. 7A is a block circuit diagram of a third embodiment of the charger of the power integration circuit with the front-end DC conversion path according to the present disclosure.

FIG. 7B is a block circuit diagram of FIG. 7A according to a first embodiment of the present disclosure.

FIG. 7C is a block circuit diagram of FIG. 7A according to a second embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

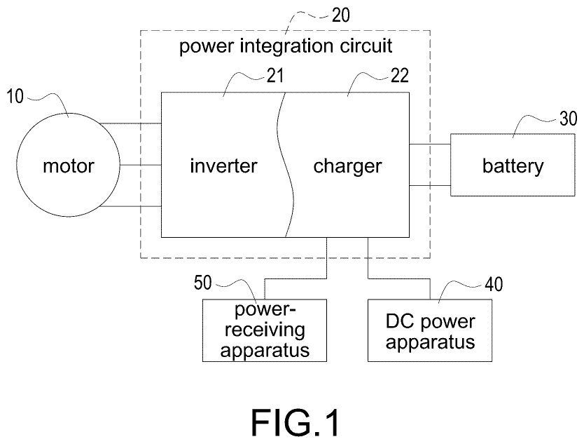

Due to the versatility of Type-C transmission cables and the convenience of USB-PD chargers, the present disclosure proposes an integrated (shared components) bidirectional charger structure as shown in FIG. 1, which combines the traditional three-phase motor driver and charger to form an integration system. The system can be directly connected to an external USB-PD through a Type-C transmission cable for charging. In addition to the charging function, the battery energy can also be provided to external apparatuses (or power-receiving apparatuses) through Type-C transmission cables, such as but not limited to light electric vehicles (such as electric scooters, electric bicycles, electric wheelchairs, electric skateboards, etc.). Accordingly, the power integration system with motor drive and battery charging and discharging function is provided to realize the structure that the power switches of a three-phase motor driver are shared in the charger, which can reduce the number of external components, thereby reducing the size and achieving high efficiency.

Please refer to FIG. 1, which shows a block diagram of the power integration system with motor drive and battery charging and discharging function used with the DC power apparatus according to the present disclosure. The power integration system with motor drive and battery charging and discharging function (hereinafter referred to as the power integration system) includes a motor 10, a power integration circuit 20, and a battery 30. The power integration circuit 20 includes an inverter 21 and a charger 22. The inverter 21 has multi-phase (for example, three-phase) bridge arms, each phase bridge arm includes an upper switch and a lower switch, and each phase bridge arm is correspondingly coupled to each phase winding of the motor. As shown in FIG. 1, three-phase paths of the motor 10 are a U-phase path, a V-phase path, and a W-phase path, respectively. The U-phase path is coupled to a U-phase inductor L₁ of the motor 10, the V-phase path is coupled to a V-phase inductor L₂ of the motor 10, and the W-phase path is coupled to a W-phase inductor L₃ of the motor 10. The charger 22 includes a switch SW, the upper switch and the lower switch of at least one bridge arm of the shared inverter 21, and the shared phase inductors L₁, L₂, L₃. In other words, the power integration circuit 20 is a shared-component circuit structure having the inverter 21 and the charger 22. Specifically, the part of the shared component is the switch SW, the upper switch and the lower switch of the at least one bridge arm, and the phase inductors L₁, L₂, L₃. Incidentally, the DC power converter of the present invention can be, for example but not limited to, a boost converter, a buck converter, a buck-boost converter, or other types of DC-DC converters, which can be designed according to the requirements of practical applications. The battery 30 is coupled to the power integration circuit 20.

The power integration system shown in FIG. 1 is a bidirectional structure. Therefore, the power integration circuit 20 receives DC power provided by a DC power apparatus 40, and the charger 22 of the power integration circuit 20 converts the DC power to charge the battery 30 so that the DC power can charge the battery 30. In one embodiment, the DC power apparatus 40 is, for example, but not limited to, USB-PD. Take the light electric vehicle-electric bicycle as an example, the motor 10, the power integration circuit 20, and the battery 30 are installed (disposed) inside the electric bicycle, and the DC power provided by the DC power apparatus 40 is an external USB-PD DC power. Therefore, when the electric bicycle is plugged into the USB-PD DC power for charging, the charger 22 of the power integration circuit 20 converts the USB-PD DC power to charge the battery 30 installed inside the vehicle body of the electric bicycle.

Moreover, the battery 30 provides power required by a power-receiving apparatus 50 through the charger 22. As mentioned above, the power-receiving apparatus 50 is, for example, but not limited to, a portable mobile apparatus (such as a mobile phone, a tablet computer, a notebook computer, etc.). When the user is outdoors, the user can plug a mobile phone, a power bank, or an electric bicycle (i.e., the power-receiving apparatus 50) into the charger 22 of the power integration circuit 20 installed inside another electric bicycle for charging, the battery 30 supplies (provides) the power required by the mobile phone through the charger 22 to charge the mobile phone, the power bank, or the electric bicycle.

Moreover, the battery 30 provides power required to drive the motor 10 through the inverter 21. When the user rides the electric bicycle outdoors, the power required to drive the motor 10 is supplied by the battery 30.

Moreover, the power-receiving apparatus 50 charges the battery 30 through the charger 22. When the electric bicycle is not in the riding state and no DC power (the USB-PD DC power) provided by the DC power apparatus 40 charges the battery 30, the battery 30 is charged by the power provided from the power-receiving apparatus 50 (i.e., the mobile phone, the power bank, or the electric bicycle). For example, when the user rides the electric bicycle outdoors and the battery 30 cannot provide the power required by the electric bicycle, the battery 30 can be charged by the power provided from the power-receiving apparatus 50 so that the electric bicycle can be ridden in a short time to the nearest place with the DC power apparatus 40 to be fully charged.

Therefore, the power integration system shown in FIG. 1 provides a bidirectional power path, including that the DC power apparatus 40 charges the battery 30 or the power-receiving apparatus 50 charging the battery 30, and the battery 30 supplies power to the power-receiving apparatus 50 or the battery 30 supplies power to the motor.

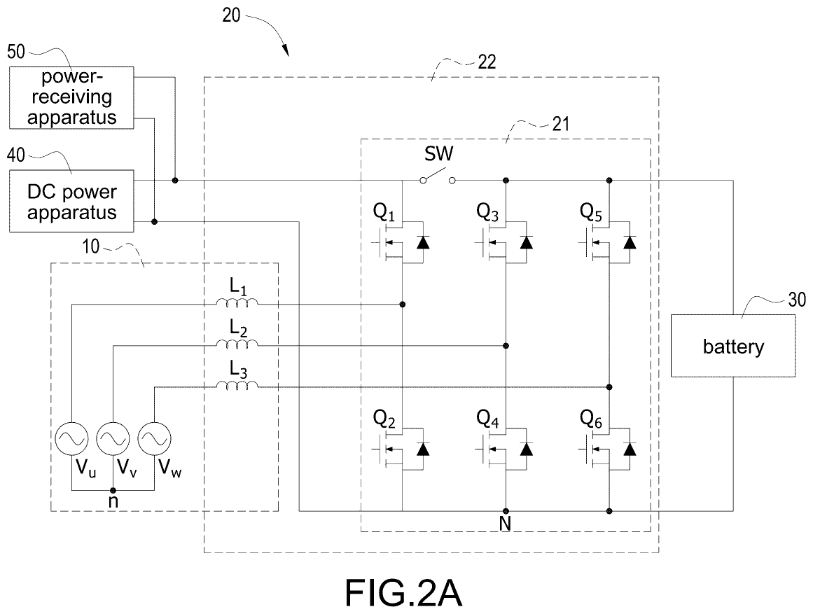

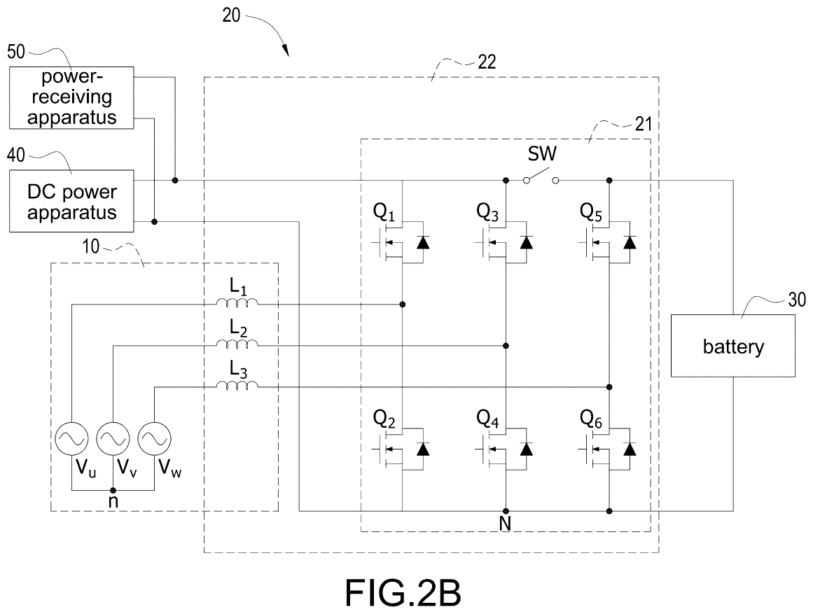

Please refer to FIG. 2A and FIG. 2B, which show block circuit diagrams of a first embodiment and a second embodiment of a charger of a power integration circuit without a front-end DC conversion path according to the present disclosure, respectively. As mentioned above, the switch SW is coupled between any two bridge arms. Specifically, as shown in FIG. 2A, the switch SW is coupled between a first bridge arm having the upper switch Q₁ and the lower switch Q₂ and a second bridge arm having the upper switch Q₃ and the lower switch Q₄, and therefore the first bridge arm is the shared bridge arm. By turning on or turning off the switch SW, the DC power provided by the DC power apparatus 40 supplies to the power integration circuit 20 through the first inductor L₁, and outputs power to the battery 30 to charge the battery 30 through the second inductor L₂ and/or the third inductor L₃. In other words, in FIG. 2A, the DC power provided from the DC power apparatus 40 is inputted to the shared first bridge arm (before the shared inductors L₁), and is outputted from the shared second bridge arm and third bridge arm, or one of the shared second bridge arm and third bridge arm (after the shared inductors L₂-L₃). Moreover, the battery 30 can provide power from the shared bridge arm(s) (shared inductor(s)), i.e., the second bridge arm and the third bridge arm, or one of the second bridge arm and the third bridge arm to the shared bridge (shared inductor), i.e., the first bridge arm to supply the power-receiving apparatus 50.

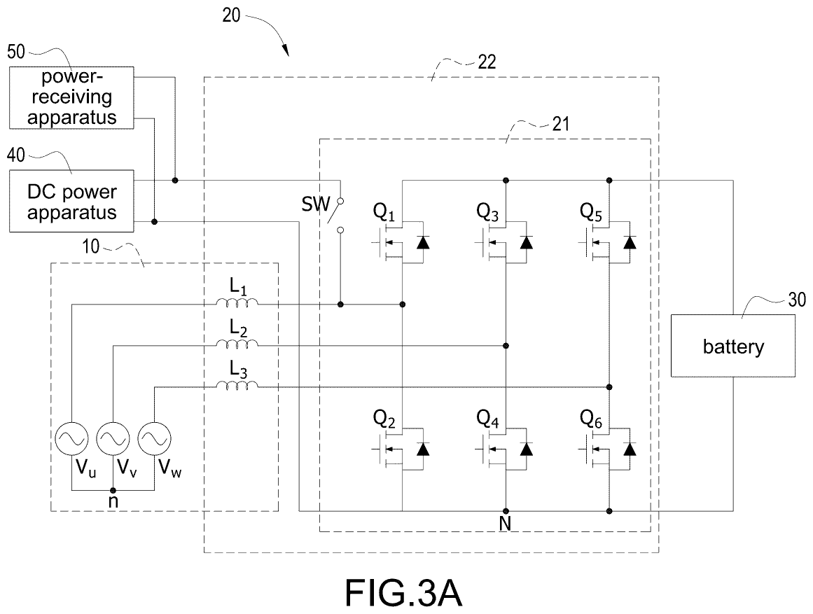

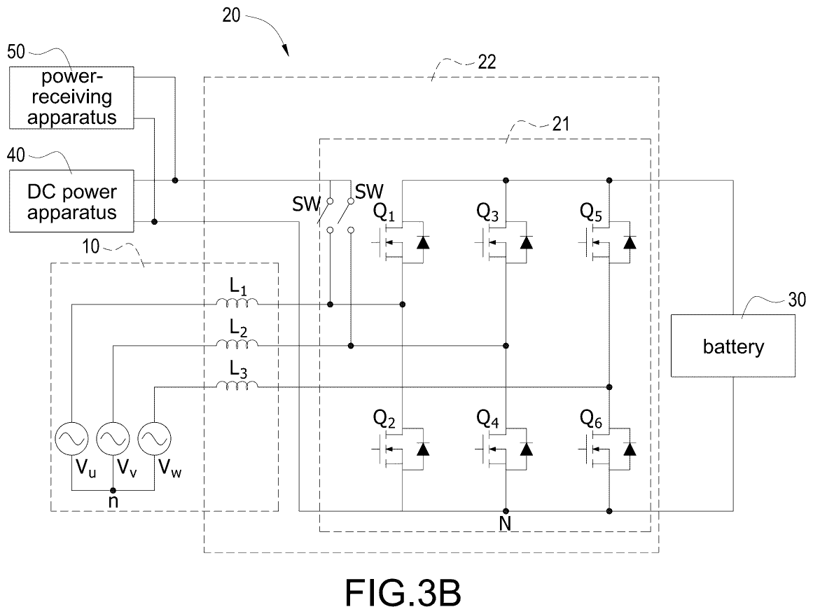

The major difference between FIG. 2B and FIG. 2A is that the switch SW is coupled between the second bridge arm having the upper switch Q₃ and the lower switch Q₄ and a third bridge arm having the upper switch Q₅ and the lower switch Q₆, and therefore the first bridge arm and the second bridge arm are the shared bridge arms. By turning on or turning off the switch SW, the DC power provided by the DC power apparatus 40 supplies to the power integration circuit 20 through the first inductor L₁ and/or the second inductor L₂, and outputs power to the battery 30 to charge the battery 30 through the third inductor L₃. In other words, in FIG. 2B, the DC power provided from the DC power apparatus 40 is inputted to the shared first bridge arm and second bridge arm, or one of the shared first bridge arm and second bridge arm (before the shared inductors L₁-L₂), and is outputted from the shared third bridge arm (after the shared inductors L₃). Moreover, the battery 30 can provide power from the shared bridge arm (shared inductor), i.e., the third bridge arm to the shared bridge(s) (shared inductor(s)), i.e., the first bridge arm and the second bridge arm, or one of the first bridge arm and the second bridge arm to supply the power-receiving apparatus 50. Please refer to FIG. 3A and FIG. 3B, which show block circuit diagrams of a third embodiment and a fourth embodiment of the charger of the power integration circuit without the front-end DC conversion path according to the present disclosure, respectively. Different from FIG. 2A and FIG. 2B, the switch SW of FIG. 3A is coupled between any one inductor L₁, L₂, L₃ and the DC power apparatus 40. As shown in FIG. 3A, the switch SW is coupled between the first inductor L₁ and the DC power apparatus 40. However, in the present disclosure, it is not limited by this position, that is, the switch SW may be coupled between the second inductor L₂ and the DC power apparatus 40. As shown in FIG. 3A, the switch SW is coupled between the first inductor L₁ and the DC power apparatus 40, or the switch SW is coupled between the third inductor L₃ and the DC power apparatus 40. For example, the DC power provided by the DC power apparatus 40 can charge the battery 30 through the shared second bridge arm and the third bridge arm, or one of the second bridge arm and the third bridge arm. Moreover, the battery 30 can provide power to supply the power-receiving apparatus 50 through the shared second bridge arm and the third bridge arm, or one of the second bridge arm and the third bridge arm.

In another embodiment, the switch SW is coupled between two inductors L₁, L₂, L₃ and the DC power apparatus 40. As shown in FIG. 3B, the switch SW is respectively coupled between the first inductor L₁ and the DC power apparatus 40 and between the second inductor L₂ and the DC power apparatus 40. However, in the present disclosure, it is not limited by this, that is, the switch SW may be respectively coupled between the second inductor L₂ and the DC power apparatus 40 and between the third inductor L₃ and the DC power apparatus 40, or the switch SW may be respectively coupled between the first inductor L₁ and the DC power apparatus 40 and between the third inductor L₃ and the DC power apparatus 40. Therefore, by turning on or turning off the switch SW, the DC power provided by the DC power apparatus 40 supplies to the power integration circuit 20 through the corresponding two inductors L₁, L₂, L₃, and outputs power to the power-receiving apparatus 50 through another inductor L₁, L₂, L₃. For example, the DC power provided by the DC power apparatus 40 can charge the battery 30 through the shared third bridge arm. Moreover, the battery 30 can provide power to supply the power-receiving apparatus 50 through the shared third bridge arm.

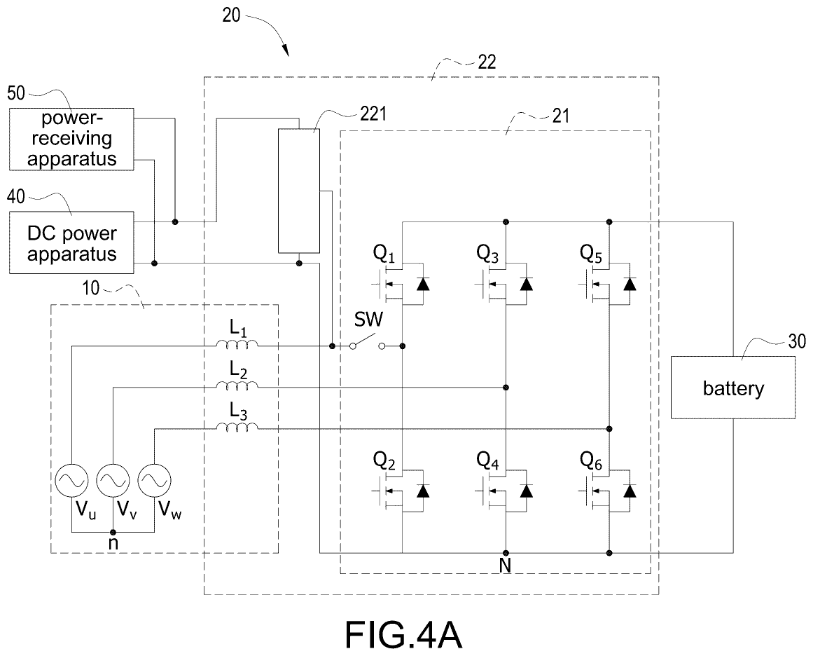

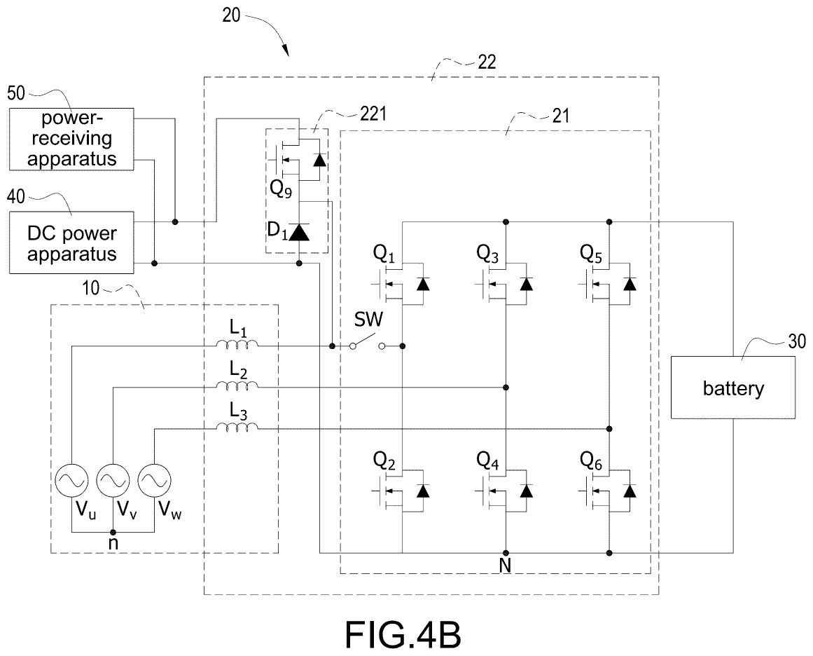

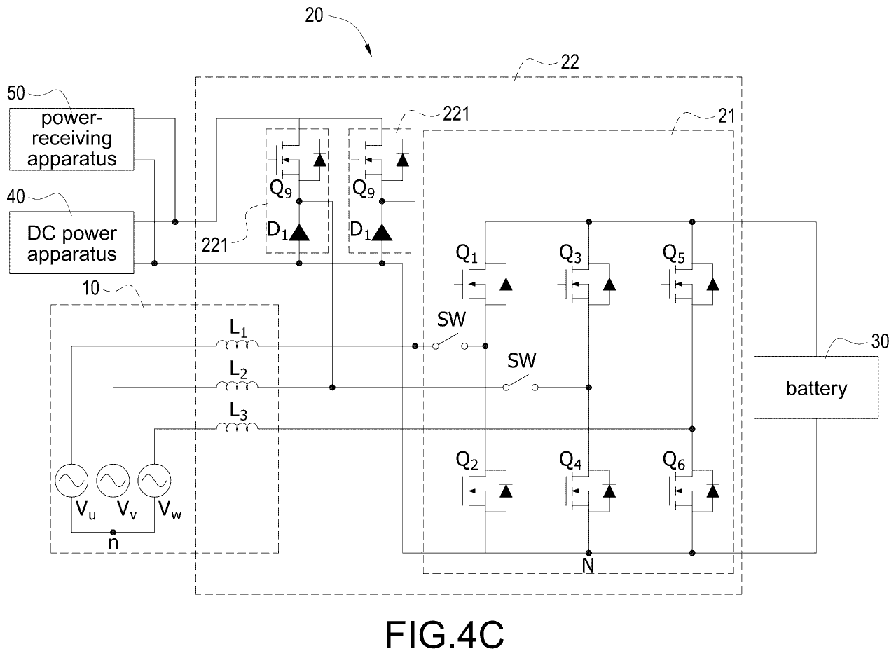

Please refer to FIG. 4A, which shows a block circuit diagram of a fifth embodiment of the charger of the power integration circuit without the front-end DC conversion path according to the present disclosure. The difference between FIG. 2B, FIG. 2A and FIG. 4A, or between FIG. 3B, FIG. 3A, and FIG. 4A is that the switch SW is coupled between any one bridge arm and the corresponding inductor L₁, L₂, L₃, and the charger 22 further includes a sub path 221. Please refer to FIG. 4B and FIG. 4C, which show block circuit diagrams of FIG. 4A according to a first embodiment and a second embodiment of the present disclosure, respectively.

As shown in FIG. 4B, the sub path 221 includes a third switch Q₉ and a first diode D₁. A common-connected node of the third switch Q₉ and the first diode D₁ is coupled to the switch SW and the corresponding inductor L₁, L₂, L₃. In this embodiment, the corresponding inductor L₁, L₂, L₃ is the first inductor L₁. However, in the present disclosure, it is not limited by this position, that is, the common-connected node of the third switch Q₉ and the first diode D₁ is coupled to the switch SW and the second inductor L₂, or is coupled to the switch SW and the third inductor L₃.

Moreover, the first diode D₁ of the sub path 221 may be replaced by another switch (i.e., a fourth switch), and therefore the common-connected node of the third switch Q₉ and the fourth switch is coupled to the switch SW and the corresponding inductor L₁, L₂, L₃.

As shown in FIG. 4C, the number of switches SW may be plural, and therefore the plurality of switches SW are correspondingly coupled to the inductors L₁, L₂, L₃. Specifically, in the second embodiment shown in FIG. 4C, the number of switches SW is two, and therefore two sub paths 221 are corresponding to the two switches SW. The first sub path 221 is coupled between the DC power apparatus 40 and the first switch SW, and the second sub path 221 is coupled between the DC power apparatus 40 and the second switch SW. The first switch SW is coupled between the first bridge arm, which includes the upper switch Q₁ and the lower switch Q₂ and the first inductor L₁, and the second switch SW is coupled between the second bridge arm, which includes the upper switch Q₃ and the lower switch Q₄, and the second inductor L₂. However, the above-mentioned two sub paths 221 are not limited to be coupled to the first bridge arm and the second bridge arm, that is, the two sub paths 221 may be coupled to any two bridge arms, and the two switches SW are coupled correspondingly between the bridge arms and the inductors L₁, L₂, L₃. Similar operations can be seen in FIG. 4B, and the detail description is omitted here for conciseness.

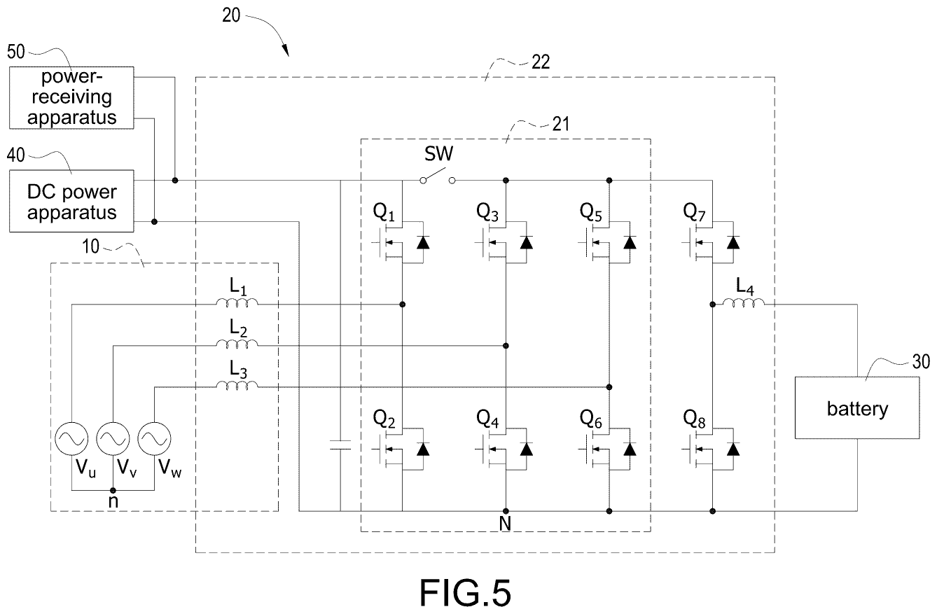

Please refer to FIG. 5, which shows a block circuit diagram of a first embodiment of the charger of the power integration circuit with the front-end DC conversion path according to the present disclosure. In comparison with FIG. 2, the charger 22 further includes a front-end DC conversion path. The front-end DC conversion path is coupled to the shared upper switch Q₅ and lower switch Q₆.

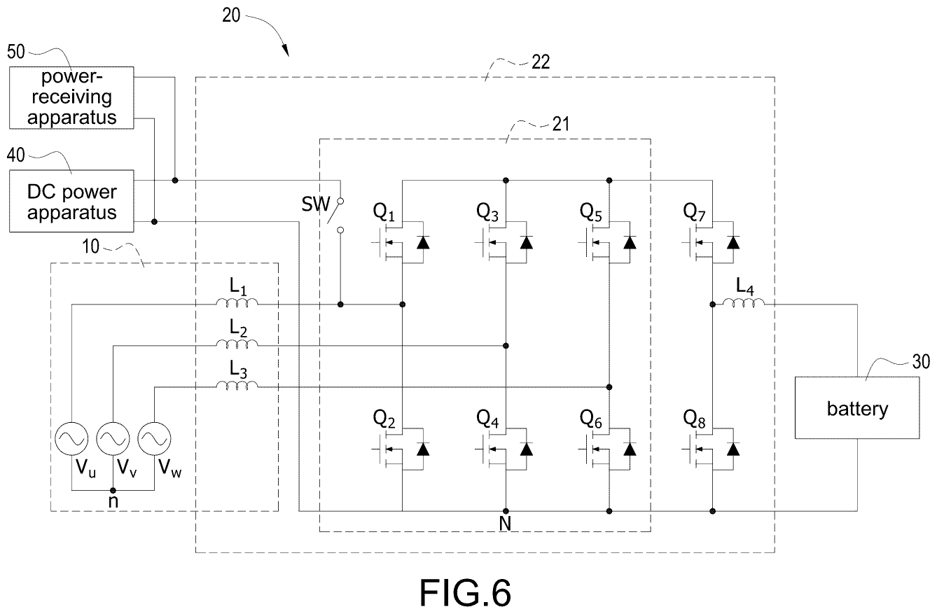

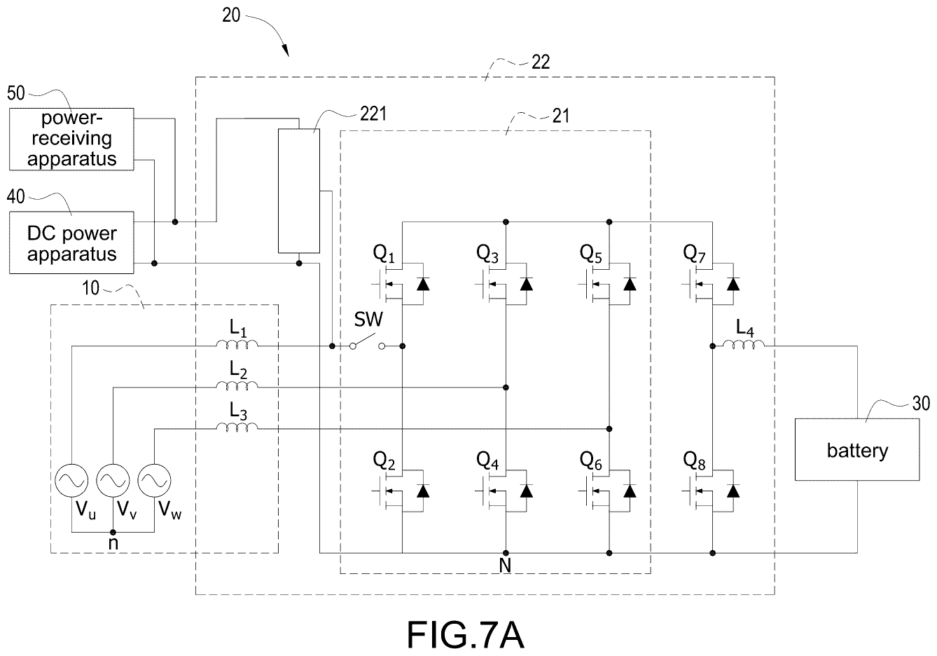

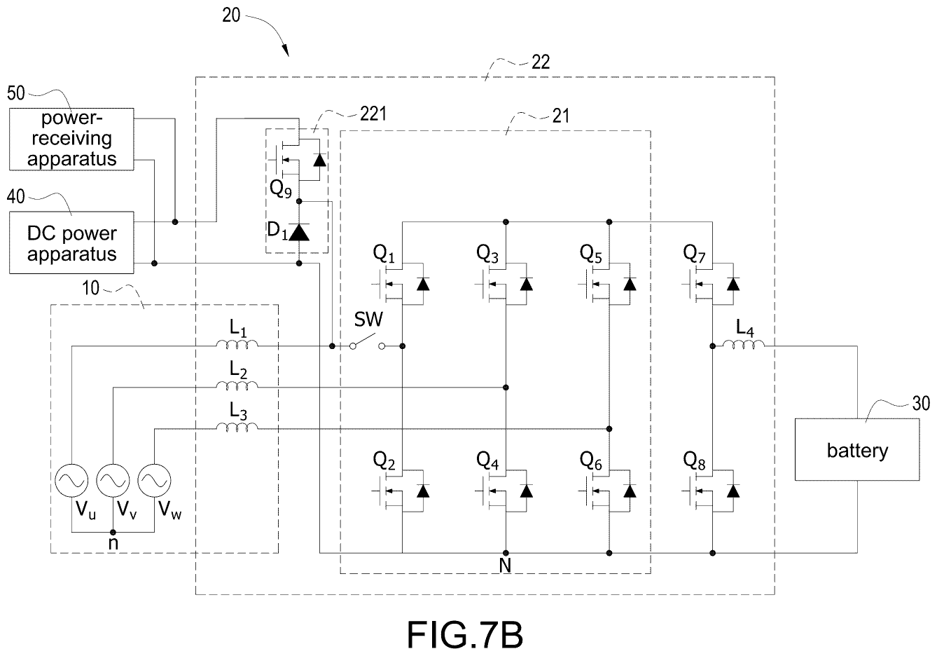

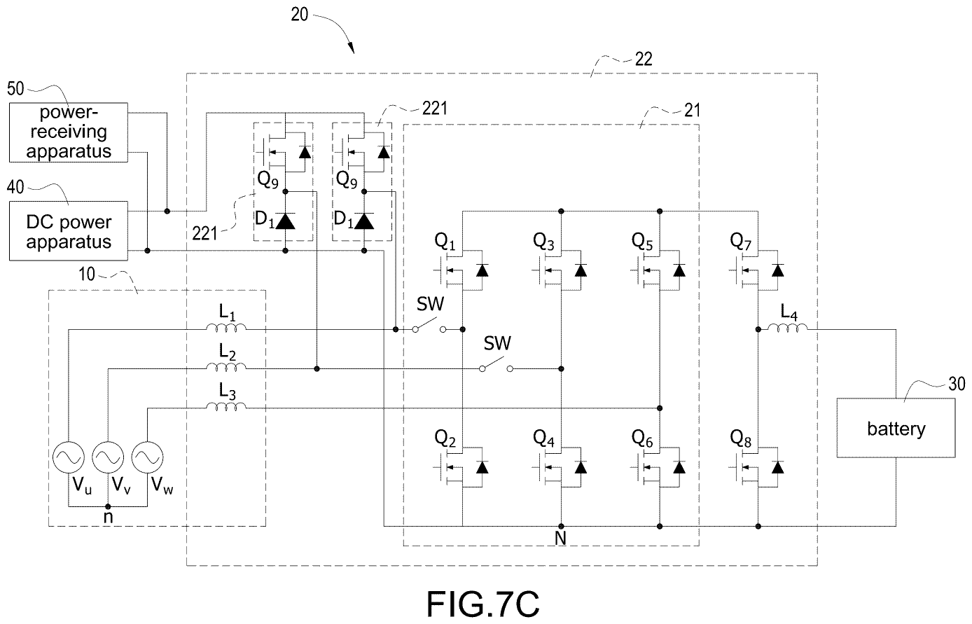

Similarly, in comparison with FIG. 3, the charger 22 shown in FIG. 6 further includes a front-end DC conversion path. The front-end DC conversion path is coupled to the shared upper switch Q₅ and lower switch Q₆. Similarly, in comparison with FIG. 4A, the charger 22 shown in FIG. 7A further includes a front-end DC conversion path. The front-end DC conversion path is coupled to the shared upper switch Q₅ and lower switch Q₆.

As shown in FIG. 5, FIG. 6, and FIG. 7A to FIG. 7C, the front-end DC conversion path includes an energy-storing inductor L₄, a first switch Q₇, and a second switch Q₈. A first end of the energy-storing inductor L₄ is coupled to a common-connected node of the first switch Q₇ and the second switch Q₈, and a second end of the energy-storing inductor L₄ is coupled to the battery 30.

Specifically, in the first embodiment shown in FIG. 7B, the number of switch SW is one, and therefore one sub path 221 is corresponding to the switch SW. The sub path 221 is coupled between the DC power apparatus 40 and the switch SW. However, the above-mentioned sub path 221 is not limited to be coupled to the first bridge arm, that is, the sub path 221 may be coupled to any one bridge arm, and the switch SW is coupled correspondingly between the bridge arm and the inductor L₁, L₂, L₃.

Specifically, in the second embodiment shown in FIG. 7C, the number of switches SW is two, and therefore two sub paths 221 are corresponding to the two switches SW. The first sub path 221 is coupled between the DC power apparatus 40 and the first switch SW, and the second sub path 221 is coupled between the DC power apparatus 40 and the second switch SW. The first switch SW is coupled between the first bridge arm, which includes the upper switch Q₁ and the lower switch Q₂, and the first inductor L₁, and the second switch SW is coupled between the second bridge arm, which includes the upper switch Q₃ and the lower switch Q₄, and the second inductor L₂. However, the above-mentioned two sub paths 221 are not limited to be coupled to the first bridge arm and the second bridge arm, that is, the two sub paths 221 may be coupled to any two bridge arms, and the two switches SW are coupled correspondingly between the bridge arms and the inductors L₁, L₂, L₃.

For the circuits shown in the previous disclosure, when a voltage of the battery 30 is greater than a reference voltage value, the charger 22 operates in a boost (step-up) mode to charge the battery 30, and when the voltage of the battery 30 is less than the reference voltage value, the charger 22 operates in a buck (step-down) mode to charge the battery 30. Moreover, the battery 30 provides power required by the power-receiving apparatus 50 through the charger 22, or the power-receiving apparatus 50 charges the battery 30 through the charger 22. Moreover, according to the power required by the power-receiving apparatus 50, the charger 22 makes the battery 30 operate in a boost (step-up) mode or a buck (step-down) mode to discharge to the power-receiving apparatus 50. However, the circuits shown in FIG. 3A, FIG. 3B, and FIG. 6, the DC power apparatus 40 or the power-receiving apparatus 50 operate in a boost mode to charge the battery 30, and the charger 22 makes the battery 30 operate in a buck (step-down) mode to discharge to the power-receiving apparatus 50.

Accordingly, the power integration system with motor drive and battery charging and discharging function is provided to realize the structure that the power switches of a three-phase motor driver are shared in the charger, which can reduce the number of external components, thereby reducing the size and achieving high efficiency.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A power integration circuit for use with a motor and a battery, the motor comprising a first inductor, a second inductor, and a third inductor, the power integration circuit comprising:
an inverter comprising a first bridge arm, a second bridge arm, and a third bridge arm, each of the first bridge arm, the second bridge arm, and the third bridge arm comprising an upper switch and a lower switch, the first bridge arm being configured to be coupled to the first inductor, the second bridge arm being configured to be coupled to the second inductor, and the third bridge arm being configured to be coupled to the third inductor; and
a charger comprising a switch, the charger being configured without a front-end DC conversion path and configured to share at least one bridge arm of the inverter and at least one inductor of the motor,
wherein the switch is configured to be coupled between a DC power apparatus and any one inductor of the first inductor, the second inductor, and the third inductor,
wherein, when the switch is coupled between the DC power apparatus and the first inductor, the charger is configured to charge the battery through the second bridge arm and the third bridge arm, or through one of the second bridge arm and the third bridge arm, and
wherein the charger is configured to operate in a boost mode to charge the battery and to operate in a buck mode to discharge the battery to a power-receiving apparatus.

2. The power integration circuit as claimed in claim 1, wherein the switch is configured to be coupled between the DC power apparatus and the first inductor.

3. The power integration circuit as claimed in claim 1, wherein the switch is configured to be coupled between the DC power apparatus and the second inductor.

4. The power integration circuit as claimed in claim 1, wherein the switch is configured to be coupled between the DC power apparatus and the third inductor.

5. The power integration circuit as claimed in claim 1, wherein the charger is configured to charge the battery through the second bridge arm and the third bridge arm.

6. The power integration circuit as claimed in claim 1, wherein the charger is configured to charge the battery through one of the second bridge arm and the third bridge arm.

7. The power integration circuit as claimed in claim 1, wherein the charger is configured to provide power from the battery to the power-receiving apparatus through the second bridge arm and the third bridge arm, or through one of the second bridge arm and the third bridge arm.

8. The power integration circuit as claimed in claim 1, wherein the at least one inductor of the motor is configured to serve as an energy-storing inductor of the charger during charging of the battery.

9. The power integration circuit as claimed in claim 1, wherein the inverter is configured to receive power from the battery to drive the motor in a motor driving operation different from charging of the battery and discharging of the battery to the power-receiving apparatus.

10. A power integration circuit for use with a motor and a battery, the motor comprising a first inductor, a second inductor, and a third inductor, the power integration circuit comprising:
an inverter comprising a first bridge arm, a second bridge arm, and a third bridge arm, each of the first bridge arm, the second bridge arm, and the third bridge arm comprising an upper switch and a lower switch, the first bridge arm being configured to be coupled to the first inductor, the second bridge arm being configured to be coupled to the second inductor, and the third bridge arm being configured to be coupled to the third inductor; and
a charger comprising a first switch and a second switch, the charger being configured without a front-end DC conversion path and configured to share at least one bridge arm of the inverter and at least one inductor of the motor,
wherein the first switch is configured to be coupled between a DC power apparatus and the first inductor,
wherein the second switch is configured to be coupled between the DC power apparatus and the second inductor,
wherein, by turning on or turning off the first switch and the second switch, DC power provided by the DC power apparatus is supplied to the power integration circuit through the first inductor and the second inductor, and power is outputted through the third inductor, and
wherein the charger is configured to operate in a boost mode to charge the battery and to operate in a buck mode to discharge the battery to a power-receiving apparatus.

11. The power integration circuit as claimed in claim 10, wherein the charger is configured to charge the battery through the third bridge arm.

12. The power integration circuit as claimed in claim 10, wherein the charger is configured to provide power from the battery to the power-receiving apparatus through the third bridge arm.

13. The power integration circuit as claimed in claim 10, wherein the first switch and the second switch are respectively configured to be coupled between the DC power apparatus and two inductors of the first inductor, the second inductor, and the third inductor.

14. The power integration circuit as claimed in claim 13, wherein another inductor of the first inductor, the second inductor, and the third inductor is different from the two inductors, and the charger is configured to output power through the another inductor.

15. The power integration circuit as claimed in claim 10, wherein the at least one inductor of the motor is configured to serve as an energy-storing inductor of the charger during charging of the battery.

16. The power integration circuit as claimed in claim 10, wherein the inverter is configured to receive power from the battery to drive the motor in a motor driving operation different from charging of the battery and discharging of the battery to the power-receiving apparatus.

17. A method for operating a power integration circuit, the power integration circuit comprising an inverter and a charger and being configured for use with a motor and a battery, the motor comprising a first inductor, a second inductor, and a third inductor, the inverter comprising a first bridge arm configured to be coupled to the first inductor, a second bridge arm configured to be coupled to the second inductor, and a third bridge arm configured to be coupled to the third inductor, and the charger being configured without a front-end DC conversion path, the method comprising:
coupling, by a switch of the charger, a DC power apparatus to any one inductor of the first inductor, the second inductor, and the third inductor;
charging the battery in a boost mode through at least one bridge arm of the inverter and at least one inductor of the motor; and
discharging the battery to a power-receiving apparatus in a buck mode through the at least one bridge arm of the inverter and the at least one inductor of the motor.

18. The method as claimed in claim 17, wherein coupling the DC power apparatus to any one inductor comprises coupling the DC power apparatus to the first inductor, and wherein charging the battery comprises charging the battery through the second bridge arm and the third bridge arm, or through one of the second bridge arm and the third bridge arm.

19. The method as claimed in claim 17, further comprising:
coupling, by a first switch of the charger, the DC power apparatus to the first inductor; and
coupling, by a second switch of the charger, the DC power apparatus to the second inductor,
wherein charging the battery comprises charging the battery through the third bridge arm.

20. The method as claimed in claim 17, further comprising driving the motor by providing power from the battery to the motor through the inverter in a motor driving operation different from charging the battery and discharging the battery to the power-receiving apparatus.
